(19) United States
(12) Patent Application Publication
(10) Pub. No.: US 2008/0116675 A1
(43) Pub. Date: May 22, 2008

(54) Steering Column Assembly Comprising a Steering Column the Tilt and Length of Which Can be Modified

(75) Inventors: Fred Eggers, Buxtehude (DE); Torsten Harms, Hamburg (DE); Holger Kittler, Hamburg (DE); Sven Sagner, Hamburg (DE)

Correspondence Address: KENYON & KENYON LLP, ONE BROADWAY, NEW YORK, NY, 10004, US

(73) Assignee: DAIMLERCHRYSLER AG, Stuttgart (DE)

(21) Appl. No.: 10/571,375

(22) PCT Filed: Aug. 13, 2004
(86) PCT No.: PCT/EP04/09105

§ 371 Date: Feb. 8, 2007

(30) Foreign Application Priority Data
Sep. 10, 2003 (DE) 103 41 604.8

(51) Int. Cl. B62D 1/19

(52) U.S. Cl. 280/775; 74/493

(57) ABSTRACT

A steering column arrangement includes a bracket which is arranged fixedly on the vehicle, a steering column which has a casing tube and a steering spindle which is mounted rotatably therein, the steering column being configured so as to be adjustable in its inclination and length, and clamping device(s) being provided for fixing the steering column. In order to increase the safety of vehicle occupants, the steering column with the clamping device(s) is connected to the bracket via a bracket slide which is mounted displaceably on the bracket, it being possible for the bracket slide to be displaced relative to the bracket only after a predetermined force which is applied to the steering column in the axial direction is exceeded, and the predetermined force being smaller than a force which may be absorbed by the clamping device(s).

### FIELD OF THE INVENTION

The present invention relates to a steering column arrangement.

### BACKGROUND INFORMATION

In modern vehicle engineering, steering columns are configured such that their inclination and length can be changed for reasons of comfort. As a result, they can be adjusted to the individual requirements of a driver. Clamping device(s) are provided for fixing the steering column in its position. Here, the clamping devices are designed such that they block the capability of changing the position of the steering column reliably and permanently. This is true, in particular, for the case in which a force which acts in the axial direction acts on the steering column, such as in the event of an accident. Secondly, the clamping devices have to be designed such that they permit a change in the position of the steering column simply when required.

A steering column of this type is described, for example, in European Published Patent Application No. 0 802 104. The steering column has a bracket which is fixed to the vehicle and on which a clamping device in the form of lamellae is mounted. The steering column is connected via the clamping device to the bracket which is fixed to the vehicle. In an open position of the clamping device, it is possible to displace the steering column with respect to the bracket. In a closed position of the clamping device, the steering column is fixed with respect to the bracket.

In order to design steering column arrangements to be safe in the event of a vehicle collision, it is conventional for a steering column which cannot be adjusted in positional terms to be fastened to a bracket which is arranged fixedly on the vehicle, such that, in the case of an accident, an axial displacement of the steering column relative to the bracket is made possible with the absorption of energy. Reference is made in this regard to German Published Patent Application No. 37 20 320, for example, in which steering column arrangement with a bracket which is arranged fixedly on the vehicle is apparent. Furthermore, a nonadjustable steering column is described which is connected to the bracket via what is referred to as a hoop. The hoop and the bracket are connected to one another via bolts. The bolts engage into slot holes which are made in the hoop and which, in the case of an accident, make it possible for the hoop to be displaced relative to the bracket with absorption of energy.

### SUMMARY

Example embodiments of the present invention may provide a steering column arrangement, in which the safety of vehicle occupants may be increased while maintaining comfort functions.

According to example embodiments of the present invention, a steering column arrangement may include a bracket which is arranged fixedly on the vehicle, and a steering column may be configured so as to be adjustable in its inclination and length for reasons of comfort. In order to fix the steering column in its position, clamping device(s) are additionally provided. In order to increase the safety of vehicle occupants in the case of a crash, a bracket slide is arranged between the bracket which is arranged fixedly on the vehicle and the steering column having the clamping device, which bracket slide is connected to the bracket such that a linear displacement of the bracket slide is possible along the bracket.

This displacement of the bracket slide with the steering column and the clamping device along the bracket does not take place until a force which acts on the steering column exceeds a predetermined force, the predetermined force being smaller than a force which may be absorbed by the clamping device. When the force which may be absorbed by the clamping device is mentioned, this means the force which the clamping device may absorb without the clamping device being released and the position of the steering column changing.

The device hereof may that, in the case of an accident, the clamping device holds the steering column in its set position, but a displacement of the bracket slide along the bracket is initiated. In other words, a second crash position adjustment possibility is provided in addition to the position adjustment possibility which is provided for reasons of comfort. The provision of an additional position adjustment may provide that every position adjustment may be assigned different resistances. Thus, for example, it may be possible to adjust the steering column for reasons of comfort without great resistances, with the result that a vehicle occupant may carry out the adjustment of the steering wheel in a simple manner. This may be the case when the occupant actively transfers the clamping device into its open position. Furthermore, in the case of a crash, the steering column may be displaced counter to a predefined resistance, with which it is possible to absorb crash energy. Separating the adjustment possibilities or adjustment apparatuses may make it possible for different resistances to be provided in a simple manner.

It is possible that the bracket has a slot which serves as a guide. A slot of this type predetermines a movement direction definitely, which may ensure that the bracket slide travels a defined path in the case of an accident. For interaction with the slotted guide, it is possible that the bracket slide has a sliding block. It is also possible to provide the sliding block on the bracket and to provide the bracket slide with a slot.

Releasable fastening device(s) may be provided which are arranged between the bracket and the bracket slide and prevent displacement of the bracket slide relative to the bracket during normal usage of the steering column. Here, the fastening device may be configured such that it releases the bracket slide relative to the bracket above a predetermined force. The force is configured such that it is lower than a force which may be absorbed by the clamping device.

Furthermore, it is possible for device(s) for reducing the friction to be provided between the bracket slide and the bracket. This may take place, for example, in the form of a lubricant which is applied between the two parts, a sliding coating or a sliding insert, etc. A reduction in the friction between the bracket slide and the bracket may provide that the force which is to be exerted to initiate the displacement movement of the bracket slide is minimized, as a result of which what is referred to as a breakaway peak, which has a positive effect on the loads which act on an occupant. In addition, a resistance which acts during the displacement of the bracket slide relative to the bracket may be set more accurately.

Furthermore, holding elements for the clamping device may be provided on the bracket slide. These holding elements may be, for example, in the form of limbs. The limbs may extend, for example, perpendicularly from the bracket slide.

In the following text, example embodiments of the present invention are explained in greater detail with reference to the appended Figures.

### BRIEF DESCRIPTION OF THE DRAWINGS

FIG. 1 is a plan view of a steering column arrangement according to an example embodiment of the present invention.

FIG. 2 is a side view of the steering column arrangement illustrated in FIG. 1.

FIG. 3 illustrates a bracket with a bracket slide of a steering column arrangement illustrated in FIG. 1, before an impact.

FIG. 4 illustrates a bracket with a bracket slide of a steering column arrangement illustrated in FIG. 1, after an impact.

### DETAILED DESCRIPTION

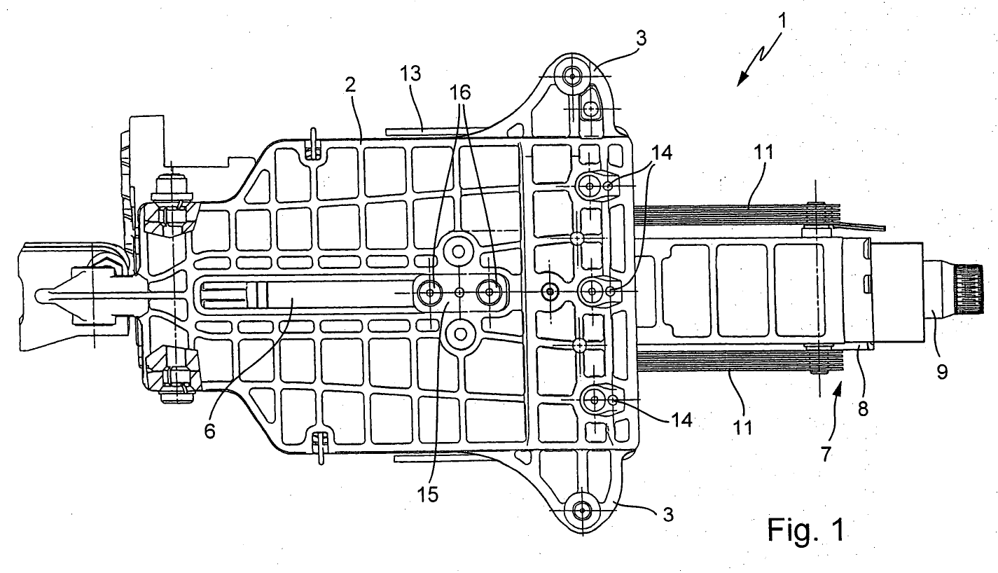

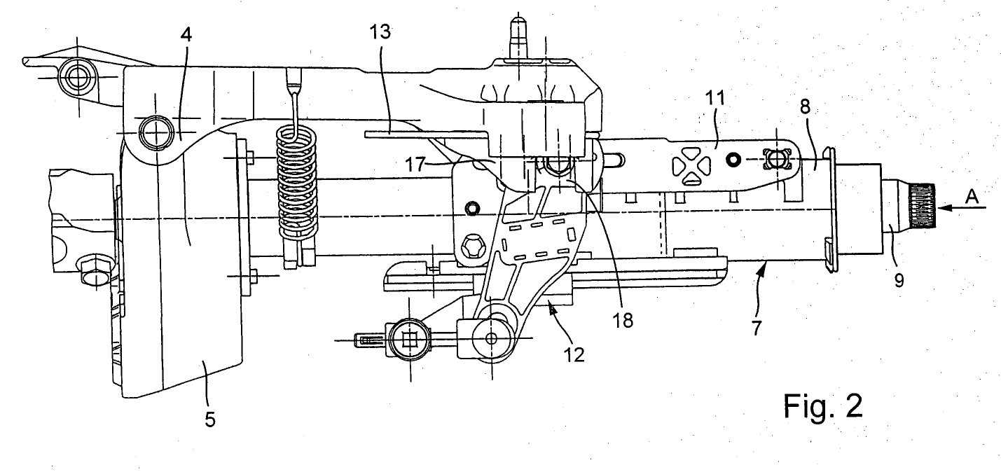

FIG. 1 illustrates a steering column arrangement 1. The steering column arrangement 1 has a bracket 2. The bracket 2 has a substantially rectangular cross-section. It has receptacles 3 for fastening device(s). The bracket 2 is mounted via fastening device(s) on a vehicle. Furthermore, receptacles 4 are provided (cf., FIG. 2) which serve to accommodate a further fastening element. The fastening element which is arranged in the receptacle 4 serves to fasten a sleeve 5. Furthermore, the bracket 2 has a slot 6 which extends over a large part of the length of the bracket 2. The function of the slot 6 is explained in greater detail in the following text.

Furthermore, the steering column arrangement 1 has a steering column 7 with a casing tube 8 and a steering column 9 which is mounted rotatably in the casing tube 8. The steering column 9 serves for holding a steering wheel and for transmitting a rotational movement which is imparted to the steering wheel by a driver to a steering gear mechanism.

In addition, lamella assemblies 11 are illustrated in FIG. 1 which are arranged on both sides of the casing tube 8 and via which it is possible to fix the steering column in a defined position. The lamella assemblies 11 interact with a clamping apparatus 12. Fixing and releasing may be carried out by increasing and reducing the pressure which prevails between the lamellae 11, and displacement or fixing of the steering column may thus be brought about.

A bracket slide 13 is arranged below the bracket 2. The bracket slide 13 is connected to the bracket 2 via fastening elements 14 and a sliding block 15. The dimensions of the sliding block 15 are adapted to the dimensions of the slot 6, and the sliding block 15 is arranged in the slot 6. The sliding block 15 is connected to the bracket slide 13 via suitable fastening elements, such as screws 16. As illustrated in FIG. 2, the clamping apparatus 12 is arranged on the bracket slide 13. For this purpose, the bracket slide 13 has limbs 17 which are arranged at an angle to it. The limbs 17 have receptacles 18, via which a connection may be produced between the bracket slide 13 and the clamping apparatus 12.

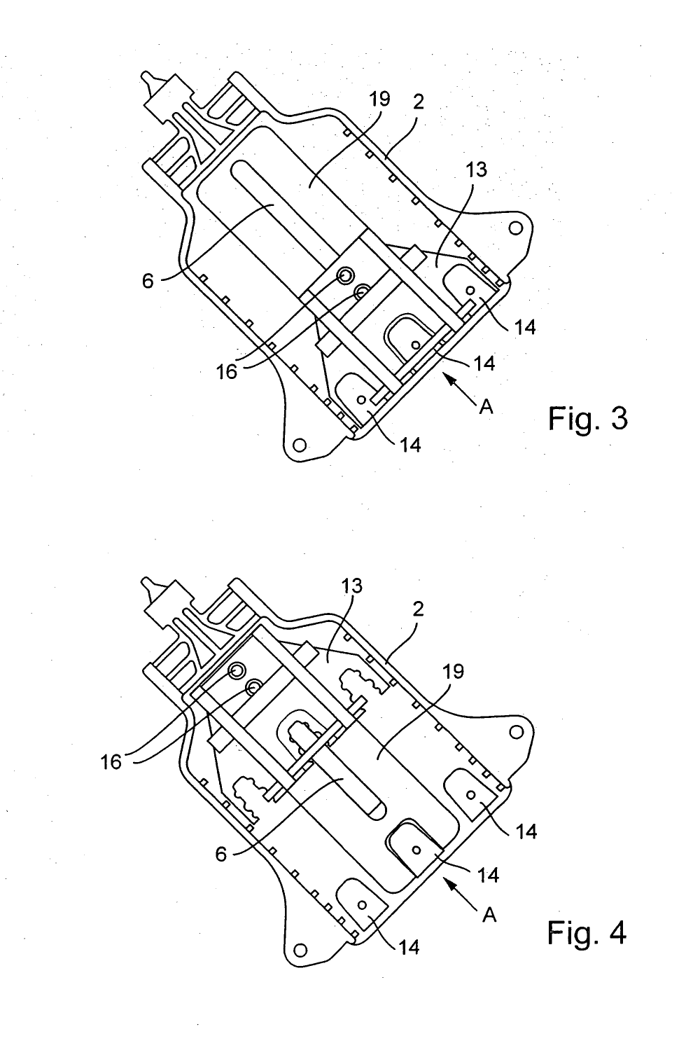

In the following text, the method of operation of the steering column arrangement 1 is explained in greater detail with reference to FIGS. 3 and 4. If, in the case of a crash, a force acts on the steering column arrangement 1 according to the arrow A, and the force A exceeds a predefined magnitude, the force A is transmitted into the bracket slide 13 via the steering spindle 9, the casing tube 8 and the clamping apparatus 12. The clamping apparatus 12 is designed such that it withstands a predefined magnitude of force, that is to say it holds the steering column 7 in its position despite this force. If the force exceeds the predefined magnitude, the fastening elements 14 are released between the bracket slide 13 and the bracket 2, which results in a movement of the bracket slide 13 then becoming possible relative to the bracket 3. The bracket slide 13 performs a defined, linear movement which is determined by the slot 6, as a result of the interaction of the sliding block 15 which is connected to the bracket slide 13 and the slot 6 of the bracket 3. Accordingly, the steering column arrangement 1 provides two possibilities for displacing the steering column 7 in the vehicle. There is one possibility after release of the clamping apparatus 12 for the purpose of adjusting the steering column 7 for comfort There is a further possibility after release of the fastening elements 14 in the case of a crash. As a result of two separate displacement or adjustment possibilities being provided, it is possible to set the resistances differently which have to be overcome during displacement of the steering column arrangement 1. It is therefore desirable for a comfort adjustment to be smooth so that it may be carried out using one hand. It is also desirable for energy to be absorbed in the event of a displacement of the steering column in a crash, that is to say for the displacement to be countered by a defined resistance. The device hereof may accomplish this in a simple manner.

FIG. 3 illustrates a bracket 2 with a bracket slide 13, to be precise before the action of the force A on the steering column arrangement 1. For clarity, an illustration of the steering column 7 which is connected to the bracket slide 13 and of the clamping apparatus 12 is omitted. However, both the fastening elements 14 between the bracket slide 13 and the bracket 2 and also the fastening elements 16 for the sliding block 15 are illustrated in FIG. 3. Furthermore, the slot 6 in the bracket 2 is illustrated, the sliding block 15 being guided by said slot 6.

If, in the case of a crash, a force A acts on the steering column arrangement 1 and the latter acts on the bracket slide 13 via the steering spindle 9, the casing tube 8 and the clamping apparatus 12, the fastening elements 14 are released and allow a movement of the bracket slide 13 with respect to the bracket 2. FIG. 4 illustrates a bracket slide 13 after a movement of this type. The bracket slide 13 is displaced along the slot 6 in the direction of the introduction of force.

Furthermore, a region 19 is illustrated in FIGS. 3 and 4 which is arranged between the bracket 2 and the bracket slide 13 and is configured such that the friction is reduced during a movement of the bracket slide 13 with respect to the bracket 2. This may take place, for example, via a special design of the surfaces of the bracket slide 13 and the bracket 2 or via conventional lubricants between the two components. The sliding surface 19 makes it possible for the force to be minimized at the instant of the release of the fastening elements 14, as a result of which firstly the loads for a vehicle occupant are reduced and secondly it is possible for an energy absorption force which is provided for energy absorption during the movement of the bracket slide 13 with respect to the bracket 2 to be set precisely. This may take place, for example, via deformation elements which may be conventional.

1-8. (canceled)

9. A steering column arrangement, comprising:
a bracket fixedly arrangeable on a vehicle;
a steering column including a casing tube and a steering spindle mounted rotatably in the casing tube, the steering column adjustable in inclination and length;
a clamp device adapted to fix the steering column; and
a bracket slide mounted displaceably on the bracket, the steering column with the clamp device connected to the bracket by the bracket slide, the bracket slide displaceable relative to the bracket only after a predetermined force applied to the steering column in an axial direction is exceeded, the predetermined force smaller than a force absorbable by the clamp device.

10. The steering column arrangement according to claim 9, wherein the bracket includes a slot arranged as a slotted guide.

11. The steering column arrangement according to claim 10, wherein the bracket slide includes a sliding block that interacts with the slotted guide.

12. The steering column arrangement according to claim 9, further comprising a releasable fastener device adapted to prevent displacement between the bracket slide and the bracket.

13. The steering column arrangement according to claim 12, wherein the fastener device is adapted to fail after a predetermined force that is applied to the steering column in the axial direction is exceeded and to release the bracket slide with respect to the bracket.

14. The steering column arrangement according to claim 9, further comprising a friction reduction device arranged between the bracket slide and the bracket.

15. The steering column arrangement according to claim 9, wherein the bracket slide includes holding elements for the clamp device.

16. The steering column arrangement according to claim 15, wherein the holding elements include limbs provided with recesses.

17. The steering column arrangement according to claim 14, wherein the friction reduction device includes a lubricant.

18. A steering column arrangement, comprising:
bracket means fixedly arrangeable on a vehicle;
steering column means including a casing tube and a steering spindle mounted rotatably in the casing tube, the steering column means adjustable in inclination and length;
clamping means for fixing the steering column; and
bracket slide means mounted displaceably on the bracket means, the steering column means with the clamping means connected to the bracket means by the bracket slide means, the bracket slide means displaceable relative to the bracket means only after a predetermined force applied to the steering column means in an axial direction is exceeded, the predetermined force smaller than a force absorbable by the clamping means.

19. A motor vehicle, comprising:
a steering column arrangement including:
a bracket fixedly arrangeable on a vehicle;
a steering column including a casing tube and a steering spindle mounted rotatably in the casing tube, the steering column adjustable in inclination and length;
a clamp device adapted to fix the steering column; and
a bracket slide mounted displaceably on the bracket, the steering column with the clamp device connected to the bracket by the bracket slide, the bracket slide displaceable relative to the bracket only after a predetermined force applied to the steering column in an axial direction is exceeded, the predetermined force smaller than a force absorbable by the clamp device.
